(19) United States
(12) Patent Application Publication
(10) Pub. No.: US 2025/0260448 A1
(43) Pub. Date: Aug. 14, 2025

(54) METHODS, DEVICES AND COMPUTER STORAGE MEDIA FOR COMMUNICATION

(71) Applicant: NEC CORPORATION, Tokyo (JP)

(72) Inventors: Gang WANG, Beijing (CN); Yukai GAO, Beijing (CN); Peng GUAN, Beijing (CN)

(73) Assignee: NEC CORPORATION, Tokyo (JP)

(21) Appl. No.: 18/833,658

(22) PCT Filed: Jan. 28, 2022
(86) PCT No.: PCT/CN2022/074820

§ 371 Date: Jul. 26, 2024

(51) Int. Cl. H04B 7/06; H04L 43/065; H04W 76/38

(52) U.S. Cl. CPC H04B 7/0626; H04L 43/065; H04W 76/38

(57) ABSTRACT

Embodiments of the present disclosure relate to methods, devices and computer storage media for communication. The method comprises receiving, at a terminal device and from a network device, a configuration of Channel State Information, CSI, report at least indicating information related to at least one of: a collection procedure of the network device for collecting one or more CSI reports collected from the terminal device; or an inference procedure of the network device for inferencing one or more CSI based on the collected one or more CSI reports; and transmitting the CSI report based on the information, wherein the CSI report comprises at least one of a periodic CSI report, a semi-persistent CSI report and a first type of CSI report.

### TECHNICAL FIELD

Embodiments of the present disclosure generally relate to the field of telecommunication, and in particular, to methods, devices and computer storage media for Channel State Information (CSI) prediction in time domain.

### BACKGROUND

Currently, it has been considered applying Artificial Intelligence/Machine Learning (AI/ML) schemes in wireless communication, especially for CSI or beam prediction in time domain. The CSI/beam prediction is a continuous process and may cause the CSI report to be configured/activated or released/deactivated by control signaling frequently.

### SUMMARY

In general, example embodiments of the present disclosure provide methods, devices and computer storage media for CSI prediction in time domain.

In a first aspect, there is provided a method. The method comprises receiving, at a terminal device and from a network device, a configuration of Channel State Information, CSI, report at least indicating information related to at least one of: a collection procedure of the network device for collecting one or more CSI reports collected from the terminal device; or an inference procedure of the network device for inferencing one or more CSI based on the collected one or more CSI reports; and transmitting the CSI report based on the information, wherein the CSI report comprises at least one of a periodic CSI report, a semi-persistent CSI report and a first type of CSI report.

In a second aspect, there is provided a method. The method comprises determining, at a network device, a configuration of Channel State Information, CSI, report at least indicating information related to at least one of: a collection procedure of the network device for collecting one or more CSI reports collected from a terminal device; or an inference procedure of the network device for inferencing one or more CSI based on the collected one or more CSI reports; and transmitting the configuration to the terminal device.

In a third aspect, there is provided a terminal device. The terminal device comprises a processor and a memory. The memory is coupled to the processor and stores instructions thereon. The instructions, when executed by the processor, cause the terminal device to perform the method according to the first aspect of the present disclosure.

In a fourth aspect, there is provided a network device. The network device comprises a processor and a memory. The memory is coupled to the processor and stores instructions thereon. The instructions, when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect or the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which embodiments of the present disclosure can be implemented;

FIG. 2 shows a signaling chart of an example process of CSI prediction in time domain in accordance with some embodiments of the present disclosure;

FIG. 3 shows a diagram of an example of CSI prediction in time domain in accordance with some embodiments of the present disclosure;

FIG. 4 show a diagram of an example of CSI prediction in time domain in accordance with some embodiments of the present disclosure;

FIGS. 5A and 5B show a diagram of an example of CSI prediction in time domain in accordance with some embodiments of the present disclosure;

FIG. 6 show a diagram of an example of CSI prediction in time domain in accordance with some embodiments of the present disclosure;

FIG. 7 show a diagram of an example of CSI prediction in time domain in accordance with some embodiments of the present disclosure;

FIG. 8 show a diagram of an example of CSI prediction in time domain in accordance with some embodiments of the present disclosure;

FIG. 9 shows a flowchart of an example method of CSI prediction in time domain in accordance with some embodiments of the present disclosure;

FIG. 10 shows a flowchart of an example method of CSI prediction in time domain in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g., signal generator, signal analyzer, spectrum analyzer, network analyzer, test terminal device, test network device, channel emulator.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (memories) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

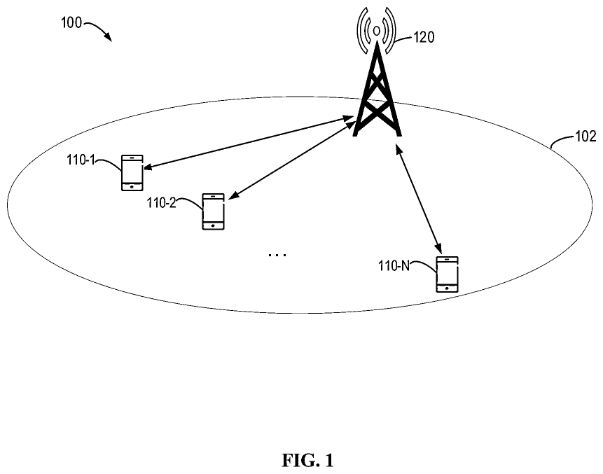

FIG. 1 shows an example communication network 100 in which embodiments of the present disclosure can be implemented. The network 100 includes a network device 120 and terminal devices 110-1, 110-2 . . . , 110-N served by the network device 120. The serving area of the network device 120 is called as a cell 102. Hereinafter, the terminal devices 110-1, 110-2 . . . , 110-N may be collectively referred to as “UE 110”, “terminal device 110” and the network device 120 may also be referred to “gNB 120”.

It is to be understood that the number of network devices and terminal devices is only for the purpose of illustration without suggesting any limitations. The communication network 100 may include any suitable number of network devices and terminal devices adapted for implementing embodiments of the present disclosure.

As described above, the topic of CSI or beam prediction in time domain based on the AI/ML, especially a discontinuous periodic CSI/beam measurement and reporting based on AI/ML has been discussed. For example, the discussion on the CSI or beam prediction in time domain may focus on the scenario of UE mobility, such as train, Hypersonic Transporter (HST) or highway.

A periodic or a semi-persistent report may need to be used for CSI/beam prediction in time domain, especially during the period when inference data is collected. The periodic or the semi-persistent report is unnecessary for inference (prediction) and application.

A periodic report may be configured or released by a Radio Resource Control (RRC) signaling, which may indicate a period, an offset (i.e., the start slot) and may be associated with the periodic CSI Reference Signal (CSI-RS) resource.

The semi-persistent report may refer to a Physical Uplink Control Channel (PUCCH) based semi-persistent CSI report and a Physical Uplink Shared Channel (PUSCH) based semi-persistent CSI report. The PUCCH based semi-persistent CSI report may be activated or deactivated by Medium Access Control-Control Element (MAC-CE), while the PUSCH based semi-persistent CSI report may be is activated or deactivated by Downlink Control Information (DCI).

For the PUCCH based semi-persistent CSI report, CSI-ReportConfigID may be activated or deactivated by MAC-CE. The period and/or offset may be configured by a RRC signaling. The PUCCH based semi-persistent CSI report may be associated with the periodic/semi-persistent CSI-RS resource.

For the PUSCH based semi-persistent CSI report, the trigger state may be selected from CSI-SemiPersistentOnPUSCH-TriggerStateList by DCI and the trigger state may be associated with semi-persistent CSI report. The period may be configured by a RRC signaling. The offset may be selected from the offsetlist (configured by RRC) by DCI. The PUSCH based semi-persistent CSI report may be associated with the periodic/semi-persistent CSI-RS resource.

The periodic CSI-RS resource may be configured or released by a RRC signaling, while the semi-persistent CSI-RS resource may be activated or deactivated by MAC-CE.

The CSI/beam prediction is a continuous process, which may refer to a data collection procedure, an inference procedure and an application procedure and so on. The periodic or the semi-persistent CSI report may need to be configured/activated or released/deactivated by control signaling frequently, which will lead to excessive signaling overhead and latency. For example, in the collection procedure, the gNB may need to collect the input data required for AI/ML network (or model), wherein the input data can be the CSIs/beams reported for N consecutive times in history, while in the inference procedure, the gNB may need to use the collected input data and the AI/ML network to predict the beam(s) applied for a period in the future.

For example, assuming that the AI/ML model is deployed in the gNB side, the gNB may configure or activate a periodic or semi-persistent CSI report and associated CSI-RS resource(s). For the scenario of the periodic CSI-RS report, the gNB may configure a periodic CSI report and associated periodic CSI resources (e.g., periodic CSI-RS resource) through respective RRCs. Then the UE may perform beam measurement based on the periodic CSI-RS resources and beam reporting in the Uplink (UL) resource associated with the periodic CSI report, assuming that the reported beams are beam-1˜beam-4 in turn. The gNB may predict the beam (for example, beam-5) in next period, e.g., period of the periodic CSI report. Then the gNB may release the configuration of the periodic CSI report and associated periodic CSI resources through respective RRCs to reduce overhead of beam measurement and reporting. Until the beam-5 is about to fail, the gNB may configure another periodic CSI report and associated periodic CSI resources through respective RRCs.

In this process, the latency of RRC signaling is large, for example, 10 ms, and the overhead of frequent configuration or release of the P CSI report/resource is also large.

For the scenario of the semi-persistent CSI report, the gNB may activate a semi-persistent CSI report and associated SP CSI resources (e.g., SP CSI-RS resource) through respective MAC-CEs. Optionally, the semi-persistent CSI report can also be activated by a DCI, the associated CSI resources can also be P CSI resources configured by an RRC. Then the UE may perform beam measurement based on the SP CSI-RS resources and beam reporting in the UL resource associated with the semi-persistent CSI report, assuming that the reported beams are beam-1˜beam-4 in turn. The gNB may predict the beam (for example, beam-5) in next period, e.g., period of the semi-persistent CSI report. Then the gNB may deactivates the semi-persistent CSI report and associated SP CSI resources through respective MAC-CEs to reduce overhead of beam measurement and reporting. Until the beam-5 is about to fail, the gNB may activates another semi-persistent CSI report and associated SP CSI resources through respective MAC-CEs.

In this process, the latency of MAC-CE signaling is large, e.g., 3 ms, and the overhead of frequent activation or deactivation of the semi-persistent CSI report/resource is also large.

In order to reduce overhead and latency of RRC/MAC-CE/DCI signaling re-configuring or activating periodic or a semi-persistent report CSI report/resource, a mechanism of AI-based beam/CSI prediction in time domain is expected to achieve to and reduce unnecessary signaling and resource overhead.

In the solution of the present disclosure, the UE may receive a configuration of CSI report form the gNB. The configuration may at least indicate information related to at least one of a collection procedure of the gNB for collecting one or more CSI reports collected from the UE or an inference procedure of the gNB for inferencing one or more CSI based on the collected one or more CSI reports. Then the UE may transmit the CSI report based on the information. The CSI report comprises at least one of a periodic CSI report, a semi-persistent CSI report and a first type of CSI report.

In this way, the signaling overhead and the latency due to the RRC/MAC-CE/DCI signaling for configuring or activating periodic or a semi-persistent report CSI report/resource may be reduced significantly.

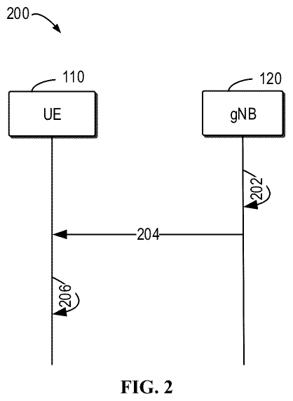

Principle and implementations of the present disclosure will be described in detail below with reference to FIGS. 2-5.

Now the reference is made to FIG. 2, which illustrates a signaling chart of an example process 200 of CSI prediction in time domain in accordance with some embodiments of the present disclosure. For the purpose of discussion, the process 200 will be described with reference to FIG. 1. The process 200 may involve the UE 110 and the gNB 120 as illustrated in FIG. 1.

As shown in FIG. 2, the gNB 120 may determine 202 a configuration of CSI report may at least indicate information related to at least one of a collection procedure of the gNB for collecting one or more CSI reports collected from the UE or an inference procedure of the gNB for inferencing one or more CSI based on the collected one or more CSI reports.

Then the gNB 120 may transmit 204 the configuration of CSI report to the UE 110. Based on the received configuration, the UE 110 may obtain the information related to at least one of a collection procedure of the gNB for collecting one or more CSI reports collected from the UE or an inference procedure of the gNB for inferencing one or more CSI based on the collected one or more CSI reports and cause 206 that the CSI is not expected to be reported to the gNB 120 based on the information.

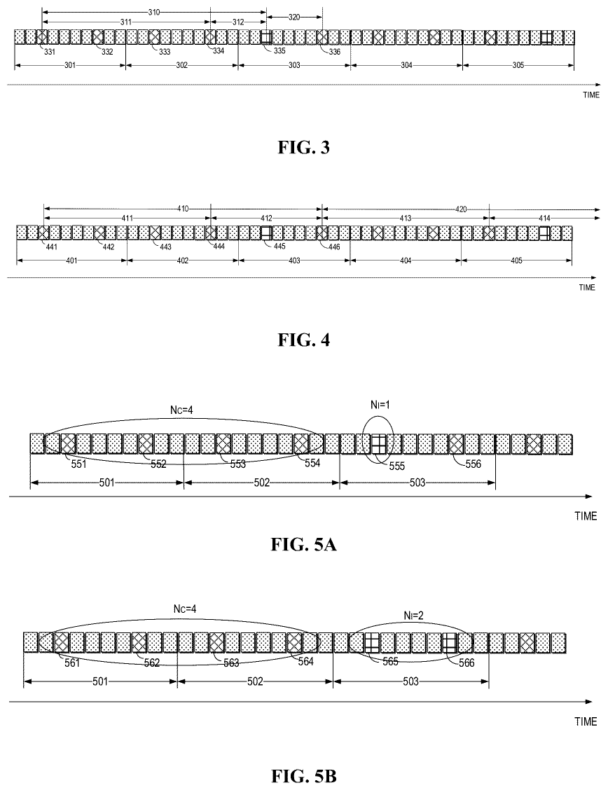

With reference to FIGS. 3-5, the process 200 may be further described in detail with embodiments as below.

In an active Downlink (DL) Bandwidth Part (BWP)/Component Carrier (CC), the UE 110 may be configured with a periodic CSI report by the gNB 120. The reporting resource (PUCCH) associated with the CSI report is allocated in an active UL BWP/CC with Sub-Carrier Spacing (SCS)=15 KHz. Thus the number of the slot in one frame Nₛₗₒₜ^{frame} is 10. For example, as shown in FIG. 3, 10 slots are included in the frame 301. The offset (i.e., the start slot) T_{offset} and period T_{CSI} of the CSI report can be 2 slots and 5 slots respectively. Assuming that the CSI report takes effect in frame 301, for example, slot 331 of the frame 301.

Based on the AI/ML network (or model), the CSI/beam corresponding to time point M (in slot 335 of frame 303) can be predicted according to the reported CSIs/beams corresponding to time point M-4 (in slot 331 of frame 301), M-3 (in slot 332 of frame 301)), M-2 (in slot 333 of frame 302) and M-1 (in slot 334 of SFN 302). Therefore, in slot 335 of SFN 303, the UE 110 may not transmit the CSI report to the gNB 120.

In some embodiments, the information comprised in the configuration of the CSI report may indicate at least one of a first time duration (hereinafter may also be referred to as “DurationofAI”) including a second time duration (hereinafter may also be referred to as “DurationofCollection”) within which the collection procedure is performed by the network device and a third time duration (hereinafter may also be referred to as “DurationofInference”) within which the inference procedure is performed by the network device.

In this case, the UE may cause, based on the information, that the CSI the CSI report is not expected to be reported to the network device within the third time duration.

In some embodiments, the periodic or the semi-persistent CSI report can be associated with a DurationofAI including a DurationofCollection and a DurationofInference, wherein the DurationofCollection is used to indicate a plurality of slots in which the gNB or UE needs to collect the input data required for inference of the AI/ML network, wherein the DurationofInference is used to indicate a plurality of slots in which the gNB or UE needs to predict (or inference) the future CSI or beam based on the AI/ML network. In other words, the DurationofCollection is used to indicate a plurality of slots in which the UE needs to transmit the periodic or the semi-persistent CSI report to the gNB, which may be like an active time of the CSI report. The DurationofInference is used to indicate a plurality of slots in which the UE does not need to transmit the periodic or the semi-persistent CSI report to the gNB, which may be like an inactive time of the CSI report.

Therefore, if the UE is configured with the DurationofAI, DurationofCollection or DurationofInference, the UE will transmit the CSI report in DurationofCollection, and the UE will drop the CSI report in DurantionofInference, or the UE does not expect to report CSI in DurationofInference, which may imply that the gNB cannot allocate CSI reporting resource.

In some embodiments, the DurationofAI, DurationofCollection or DurationofInference can be configured or updated by a control signaling, such as a RRC signaling, a MAC-CE or DCI.

In some embodiments, the DurationofAI includes am Offset_DurationofAI indicating the start slot (i.e., offset) of the DurationofAI and a Period_DurationofAI indicating the period of the DurationofAI.

In some embodiments, the Offset_DurationofAI or Period_DurationofAI can be configured or updated by a control signaling, such as a RRC signaling, a MAC-CE or DCI.

In some embodiments, the UE may assume that the offset or period of the DurationofAI is the same as the offset or period of the associated periodic or a semi-persistent report. For example, as shown in FIG. 3, the DurationofCollection 311 and DurationofInference 312 are 16 slots and 5 slots respectively (i.e., the DurationofAI 310 is 21 slots), the offset and period of the DurationofAI 320 are 2 slots and 5 slots respectively.

In some embodiments, it is also possible that the UE shall assume that the period of the DurationofAI is 0, i.e., after the first DurationofAI ends, the second DuratonofAI will start immediately after the first DurationofAI. As shown in FIG. 4, the DurationofCollection 411 and DurationofInference 412 are 16 slots and 9 slots respectively, the offset and period of the DurationofAI are 2 slots and 0 slots respectively.

The DurationofCollection and the DurationofInference as shown in FIGS. 3 and 4 are non-overlapping, i.e., i.e., the DurationofInference starts in the first slot after the end of the DurationofCollection. It is also possible that the DurationofInference may start before the end of the DurationofCollection, i.e., the DurationofCollection and the DurationofInference are partial overlapping, or even full overlap.

In some embodiments, the information comprised in the configuration of the CSI report may indicate a first number (hereinafter may also be referred to as N_{C}) associated with the collection procedure and a second number (hereinafter may also be referred to as N_{I}) associated with the inference procedure.

In this case, the UE may determine, based on the first and the second numbers, the resources in the time domain on which the CSI report is not expected to be reported to the gNB 120.

In some embodiments, the periodic or the semi-persistent report CSI report may be associated with a NofAI including a N_{C} (N_{C}>=1) and a N_{I} (N_{I}>=1), wherein the N_{C} means that N_{C} continuously reported CSIs/beams need to be used as input data of AI/ML network, while the N_{I} refers to the number of prediction results output by the AI/ML network. FIG. 5A and 5B show examples of CSI prediction corresponds to N_{C}=4, N_{I}=1 and N_{C}=4, N_{I}=2 respectively. In other words, for example, as shown in FIG. 5A, in N_{C} consecutive CSI reporting times, e.g., time point M-4 (slot 551), M-3 (slot 552), M-2 (slot 553) and M-1(slot 554), the UE needs to transmit the CSI report. In N_{I} consecutive CSI reporting times, e.g., time point M (slot 555), the UE does not need to report the CSI (or transmit the CSI report).

Therefore, if the UE is configured with the NofAI, N_{C} or N_{I}, the UE may drop the M-th CSI report, wherein the value of M satisfying:

$$M = {N}_{C} + {n}_{I} + ( m - 1 ) ( {N}_{C} + {N}_{I} ) , \\ where \\ {n}_{I} = 1 , 2 … , {N}_{I} , m = 1 , 2 , … \qquad ( 1 )$$

Specifically, the UE may drops the M-th CSI report, which is equivalent to the UE does not expect to report CSI (or transmit the CSI report) in (the slot corresponding to) the M-th PUCCH resource associated with the CSI report. Further, the M-th PUCCH resource associated with the CSI report refers to the M-th P/SP PUCCH transmission according to the RRC configuring the P CSI report or the MAC-CE activating the semi-persistent CSI report. E.g., the first PUCCH resource associated with the CSI report refers to the initial periodic PUCCH transmission according to the RRC configuring the periodic CSI report.

In some embodiments, the NofAI, NC or N_{I} can be configured or updated by a control signaling, such as a RRC signaling, a MAC-CE or DCI.

According to the existing specification, for the configured periodic or a semi-persistent report CSI report, the UE may transmit the CSI report in slot n_{s,f}^{μ} of SFN n_{f}, wherein the SFN n_{f} and the slot number within the frame n_{s,f}^{μ} need to satisfying below.

For the periodic or the semi-persistent CSI report based on the PUCCH, the periodic T_{CSI} and the slot offset T_{offset} are configured by the higher layer parameter reportSlotConfig. Unless specified otherwise, the UE shall transmit CSI report in frames with SFN n_{f} and slot number within the frame n_{s,f}^{μ} satisfying:

$$( {N}_{slot}^{frame , μ} {n}_{f} + {n}_{s , f}^{μ} - {T}_{offset} ) mod {T}_{CSI} = 0 \qquad ( 2 )$$

where μ is the SCS configuration of the UL BWP the CSI is transmitted on.

For the semi-persistent CSI report based on the PUSCH, the periodic T_{CSI} is configured by the higher layer parameter reportSlotConfig. Unless specified otherwise, the UE shall transmit CSI report in frames with SFN n_{f} and slot number within the frame n_{s,f}^{μ} satisfying:

$$( {N}_{slot}^{frame , μ} ( {n}_{f} - {n}_{f}^{start} ) + {n}_{s , f}^{μ} - {n}_{s , f}^{start} ) mod {T}_{CSI} = 0 \qquad ( 3 )$$

where n_{f}^{start} and n_{s,f}^{start} are the SFN and the slot number within the frame respectively of the initial semi-persistent PUSCH transmission according to the activating DCI.

It is to be understood that the n_{f} and n_{s,f}^{μ} satisfying the above conditions (called as determined n_{f} and n_{s,f}^{μ} for short) may have multiple values. Actually, each CSI report associated with the the periodic or the semi-persistent report may correspond a specific n_{f} and n_{s,f}^{μ}.

In some embodiments, the multiple determined n_{f} and n_{s,f}^{μ} can be represented by n_{f}⁽ⁱ⁾ and n_{s,f}^{μ (i)}, i≥0 respectively in ascending order. Specifically, the n_{f}⁽ⁱ⁾ and n_{s,f}^{μ (i)} refer to the (i+1)-th determined n_{f} and n_{s,f}^{μ}, respectively.

For the periodic or the semi-persistent CSI report based on PUCCH, the n_{f}⁽⁰⁾ and n_{s,f}^{μ (0)} refer to the SFN and slot number within the frame respectively of the initial the periodic or the semi-persistent PUCCH transmission according to the RRC configuring the periodic CSI report or the MAC-CE activating the semi-persistent CSI report.

For semi-persistent CSI report based on PUSCH, the n_{f}⁽⁰⁾ and n_{s,f}^{μ (0)} refer to the SFN and slot number within the frame respectively of the initial semi-persistent PUSCH transmission according to the DCI activating the semi-persistent CSI report.

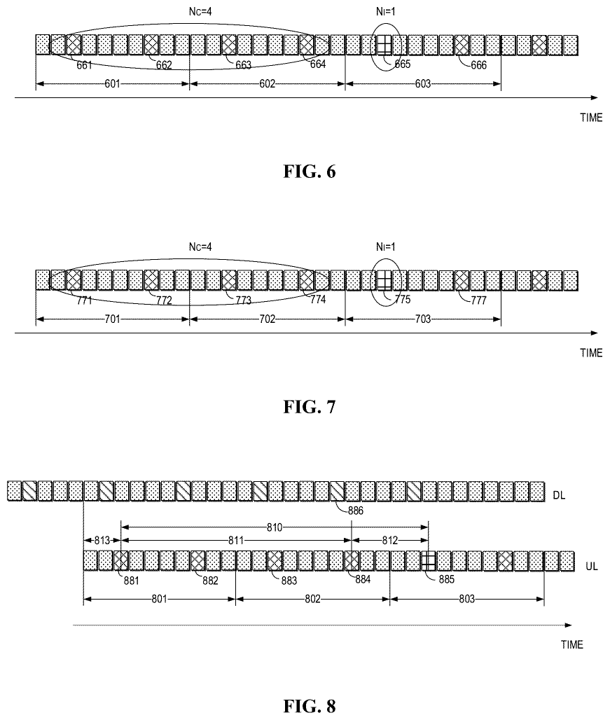

FIG. 6 shows a diagram of an example of CSI prediction in time domain in accordance with some embodiments of the present disclosure. As shown, assuming that the configured P CSI report takes effect from the SFN 1. The UE needs to transmit the CSI report in slot 661 of frame 601, slot 602 of frame 601, slot 663 of frame 602, slot 664 of frame 602, slot 665 of frame 603, slot 665 of frame 603, . . . . Therefore, the n_{f}⁽⁰⁾ and n_{s,f}^{μ (0)} are 1 and 2 respectively, the n_{f}⁽¹⁾ and n_{s,f}^{μ (1)} are 1 and 7 respectively, the n_{f}⁽²⁾ and n_{s,f}^{μ (2)} are 2 and 2 respectively, the n_{f}⁽³⁾ and n_{s,f}^{μ (3)} are 2 and 7 respectively, the n_{f}⁽⁴⁾ and n_{s,f}^{μ (4)} are 3 and 2 respectively, the n_{f}⁽⁵⁾ and n_{s,f}^{μ (5)} are 3 and 7 respectively, the n_{f}⁽⁶⁾ and n_{s,f}^{μ (6)} are 4 and 2 respectively, i.e., n_{f}ⁱ=1, 1, 2, 2, 3, 3, 4, . . . n_{s,f}^{μ i}=2, 7, 2, 7, 2, 7, 2, . . .

If the UE is configured with the NofAI, N_{C} or N_{I}, the UE may drop the CSI report in the SFN n_{f} and the slot number within the frame n_{s,f}^{μ} satisfying:

$${n}_{f} = {n}_{f}^{i} \\ {n}_{s , f}^{μ} = {{n}_{s , f}^{μ}}^{i} \\ i = {N}_{C} + {n}_{I} + ( m - 1 ) ( {N}_{C} + {N}_{I} ) - 1 , \\ where \\ {n}_{I} = 1 , 2 … , {N}_{I} , m = 1 , 2 … \qquad ( 4 )$$

In other words, the UE does not expect to report the CSI in the SFN and the slot number within the frame satisfying the above conditions.

FIG. 7 shows a diagram of an example of CSI prediction in time domain in accordance with some embodiments of the present disclosure. As shown, assuming that N_{C}=4, N_{I}=1. The value of i can be determined according to N_{C} and N_{I}. And the value of i is 4. So the UE may drop the CSI report in the SFN n_{f} and the slot number within the frame n_{s,f}^{μ} satisfying the following conditions, i.e., in slot 775 of frame 703.

In some embodiments, the gNB 120 may indicate to the UE that the CSI report to be reported is a discontinuous periodic type CSI report (DP CSI).

For the configuration or parameter of DP CSI report, the configuration or parameters related to the periodic or the semi-persistent CSI report in release 15 or 16 can be reused, except that the DP CSI report is associated with new parameter(s), such as DurationofAI, NofAI etc., as described above.

In some embodiments, The DP CSI report can be configured or released by RRC, activated or deactivated by MAC-CE/DCI. For example, similar to periodic CSI report, the DP CSI report (period and offset) may be configured by RRC. An another option, similar to PUCCH-based semi-persistent CSI report, DP CSI report (period and offset) can be configured by RRC and activated by MAC-CE. It is also possible that similar to PUSCH-based semi-persistent CSI report, a trigger state list associated with multiple DP CSI reports (period) may be configured by RRC and a trigger state (offset) may be activated by DCI. For example, the DCI may be scrambled with a new radio network temporary identity (RNTI), for example, DP-CSI-RNTI.

For the possible CSI-RS resource configuration of the DP CSI report, the periodic or the semi-persistent CSI-RS resource can be supported.

Specifically, if DL report is configured by RRC, the periodic CSI-RS resource can only be supported. If DL report is configured by and activated by MAC-CE/DCI, the periodic or the semi-persistent CSI-RS resource can be supported. For example, the supported combinations of the CSI reporting configurations and CSI-RS resource configurations and how the CSI reporting is triggered for each CSI-RS resource configuration can be shown as below.

TABLE 1
supported combinations of the CSI reporting configurations and CSI-RS resource configurations
and how the CSI reporting is triggered for each CSI-RS resource configuration

| | | Semi- | | | DP CSI |
|---|---|---|---|---|---|
| | | persistent | | | reporting |
| CSI-RS | Periodic CSI | CSI | AP CSI | DP CSI reporting | (MAC- |
| Configuration | reporting | reporting | reporting | (RRC) | CE/DCI) |
| P CSI-RS | No dynamic | For | Triggered by | No dynamic | For |
| | triggering/activation | reporting on | DCI; | triggering/activation | reporting on |
| | | PUCCH, the | additionally, | | PUCCH, the |
| | | UE receives | subselection | | UE receives |
| | | an activation | indication | | an activation |
| | | command; | | | command; |
| | | for reporting | | | for reporting |
| | | on PUSCH, | | | on PUSCH, |
| | | the UE | | | the UE |
| | | receives | | | receives |
| | | triggering on | | | triggering on |
| | | DCI | | | DCI |
| SP CSI-RS | Not Supported | For | Triggered by | Not Supported | For |
| | | reporting on | DCI; | | reporting on |
| | | PUCCH, the | additionally, | | PUCCH, the |
| | | UE receives | subselection | | UE receives |
| | | an activation | indication | | an activation |
| | | command; | | | command; |
| | | for reporting | | | for reporting |
| | | on PUSCH, | | | on PUSCH, |
| | | the UE | | | the UE |
| | | receives | | | receives |
| | | triggering on | | | triggering on |
| | | DCI | | | DCI |
| AP CSI-RS | Not Supported | Not | Triggered by | Not Supported | Not |
| | | Supported | DCI; | | Supported |
| | | | additionally, | | |
| | | | subselection | | |
| | | | indication | | |

In some embodiments, in order to save Central Processing Units (CPUs) for the configured CSI report, the UE can release CPUs during the period when the CSI report is not required.

Specifically, for a CSI report, if satisfying the conditions such as if the periodic or the semi-persistent CSI report is associated with the DurationofAI, DurationofCollection or DurationofInference, or if the periodic or the semi-persistent CSI report is associated with the NofAI, N_{C} or N_{I}, or If the CSI report is a DP CSI report (hereinafter may also be referred to satisfying first type of conditions), the UE may only occupy CPU(s) in DurationofCollection or occupy CPU(s) excluding the report in DurationofInference. Further, the UE may also save the CPU(s) based on the value of M corresponding to the report satisfying the Equation (1) or based on the SFN n_{f} and the slot number within the frame n_{s,f}^{μ}, corresponding to the report satisfying Equation (4).

For the CSI report that is not required, the UE may not receive the CSI-RS associated with the report to save power consumption. At the same time, the CSI-RS resource may not be configured by the gNB to save overhead of CSI measurement. FIG. 8 shows a diagram of an example of CSI prediction in time domain in accordance with some embodiments of the present disclosure. For example, as shown in FIG. 8, the UE does not expect to report CSI in time point M (in UL: the slot 885 of frame 803), and the CSI-RS transmission or reception (in DL: the slot 886 of frame 802) associated with the CSI report in M is not expected.

For a CSI report, if satisfying the first type of conditions, for the periodic or the semi-persistent CSI-RS, as an option, the UE will omit the CSI-RS resource(s) for channel measurement in latest CSI-RS occasion no later than the CSI reference resource corresponding to the CSI report in the DurationofInference. As another option, the UE does not receive the CSI-RS(s) for channel measurement from the first symbol after the PUCCH/PUSCH carrying the latest CSI report to the last symbol before the CSI reference resource corresponding to the CSI report in the DurationofInference.

It is also possible that the UE will omit the CSI-RS resource(s) for channel measurement in latest CSI-RS occasion no later than the CSI reference resource corresponding to the CSI report and the value of M corresponding to the report satisfying Equation (1), or the SFN n_{f} and the slot number within the frame n_{s,f}^{μ} corresponding to the report satisfying Equation (4).

In other words, the UE does not receive the CSI-RS(s) for channel measurement from the first symbol after the PUCCH/PUSCH carrying the latest CSI report to the last symbol before the CSI reference resource corresponding to the CSI report and the value of M corresponding to the report satisfying Equation (1), or the SFN n_{f} and the slot number within the frame n_{s,f}^{μ} corresponding to the report satisfying Equation (4).

Furthermore, if the gNB does not need to transmit periodic or the semi-persistent CSI-RS within a certain period of time, the corresponding physical resources can be used for data transmission, e.g., PDSCH. Therefore, for PDSCH mapping to virtual resource blocks, the UE shall assume that the corresponding physical resource blocks that are used for the CSI-RS(s) (i.e., Non Zero Power (NZP) CSI-RS) can be available for PDSCH.

Moreover, the time interval between the activate command indicating/updating beam (i.e., Transmission Coordination Indicator (TCI) state) and the last recent CSI-RS is required to be within 1280 ms. When multiple beams can be predicted, and if the UE does not receive the above CSI-RS(s) corresponding to the CSI report in the DurationofInference, the time interval is likely to be bigger than 1280 ms (considering that the maximum period of periodic CSI-RS is 640 ms). Therefore, in order to resolve this problem, as an option, the value of DurationofInference may be limited to a threshold less than 1280 ms. As another option, the above CSI report also needs to satisfying: the time interval between the CSI report and the last recent CSI-RS is less than 1280 ms.

According to the existing specification, the UE supports only a limited number of active CSI-RS resources in an active BWP. In some embodiments, if the CSI report associated with the CSI-RS satisfying the first type of conditions, the CSI-RS is inactive in a duration of time starting from the first symbol after the PUCCH/PUSCH carrying the latest CSI report to the last symbol before the CSI reference resource corresponding to the CSI report associated with CSI-RS, wherein the CSI report satisfying, for example, in the DurationofInference, or the value of M corresponding to the report satisfying Equation (1) or the SFN n_{f} and the slot number within the frame n_{s,f}^{μ} corresponding to the report satisfying Equation (4).

Furthermore, the periodic or the semi-persistent CSI report associated with the DurationofAI or NofAI, or the DP CSI report may be collided with another CSI report in time domain, especially another periodic or the semi-persistent CSI report. In this case, the priority of these CSI report needs to be clarified. Generally, because the collected data is used to predict the future CSI or beam, the CSI report used for AI/ML-based CSI/beam prediction should have higher priority when the time domain types of these collided CSI report are the same.

Therefore, if a CSI report associated with the DurationofAI or NofAI is collided with another CSI report not associated with the DurationofAI or NofAI, and their types are the same, the UE will send the CSI report associated with the DurationofAI or NofAI preferentially.

For example, y=1 for semi-persistent CSI report to be carried on PUSCH and associated with the DurationofAI or NofAI, y=2 for semi-persistent CSI report to be carried on PUSCH and not associated with the DurationofAI or NofAI, y=3 for semi-persistent CSI report to be carried on PUCCH and associated with the DurationofAI or NofAI, y=4 for semi-persistent CSI report to be carried on PUCCH and not associated with the DurationofAI or NofAI, y=5 for semi-persistent CSI report to be carried on PUSCH and associated with the DurationofAI or NofAI, y=6 for semi-persistent CSI report to be carried on PUSCH and not associated with the DurationofAI or NofAI.

As another option, the priority value may be determined according to y, w, k, c, s. For example,

$${Pri}_{iCSI} ( y , w , k , c , s ) = 3 \cdot {N}_{cells} \cdot {M}_{s} \cdot y + 2 \cdot {N}_{cells} \cdot {M}_{s} \cdot w + {N}_{cells} \cdot {M}_{s} \cdot k + {M}_{s} \cdot c + s \qquad ( 5 )$$

where y=0 for aperiodic CSI report to be carried on PUSCH, y=1 for semi-persistent CSI report to be carried on PUSCH, y=2 for semi-persistent CSI report to be carried on PUCCH and y=3 for periodic CSI report to be carried on PUCCH; and k=0 for CSI report carrying Layer 1 Reference Signal Received Power (L1-RSRP) and k=1 for CSI report not carrying L1-RSRP or L1; c is the serving cell index, N_{cells} is the value of the higher layer parameter maxNrofServingCells; and s is the reportConfigID; Mₛ is the value of higher layer parameter maxNrof-ReportConfiguartions; and w=0 for CSI reports associated with DurationofAI or NofAI and w=1 for CSI reports not associated with DurationofAI or NofAI.

Furthermore, if a DP CSI report associated with the DurationofAI or NofAI is collided with a periodic or the semi-persistent CSI report, the UE may send the DP CSI report preferentially.

For example, the DP CSI report may be configured by RRC, similar to the periodic CSI report. As an option, y=3 for DP CSI report to be carried on PUCCH, y=4 for periodic CSI report to be carried on PUCCH. As another option, y=1 for DP CSI report to be carried on PUCCH, y=2 for semi-persistent CSI report to be carried on PUSCH, y=3 for semi-persistent CSI report to be carried on PUCCH, y=4 for periodic CSI report to be carried on PUCCH

For example, the DP CSI report may be activated by MAC-CE/DCI, similar to the semi-persistent CSI report. As an option, y=1 for DP CSI report to be carried on PUSCH, y=2 for DP CSI report to be carried on PUCCH, y=3 for semi-persistent CSI report to be carried on PUSCH, y=4 for semi-persistent CSI report to be carried on PUCCH, y=5 for periodic CSI report to be carried on PUCCH.

As described above, the gNB may determine the configuration of the CSI report including information to cause the UE to determine that a reporting of a CSI report within specific time duration to be dropped. In some embodiments, the gNB may configure the above parameters based on a capability indicating that the UE supports AI/ML-based CSI/beam prediction in time domain, or indicating that the UE supports AI/ML.

For example, the gNB can configure or determine the value of the DurationofAI, DurationofCollection or DurationofInference, N_{C} or N_{I} according to a capability reported by the UE, which may include, for example, the value of the DurationofAI can be determined based on a UE's capability: maxDurationofAI, which refers to the maximum value of the DurationofAI that the UE can support; the value of the DurationofCollection can be determined based on a UE's capability: maxDurationofCollection, which refers to the maximum value of the DurationofCollection that the UE can support; the value of the DurationofInference can determined based be on a UE's capability: maxDurationofInference, which refers to the maximum value of the DurationofInference that the UE can support; the value of the N_{C} can be determined based on a UE's capability: maxN_{C}, which refers to the maximum value of the N_{C} that the UE can support; or the value of the N_{I} can be determined based on a UE's capability: maxN_{I}, which refers to the maximum value of the N_{I} that the UE can support.

In some embodiments, for the UE, the AI/ML (inference) function can be controlled by the gNB. Specifically, the gNB can turn on or off the AI/ML function through a specific control signaling (RRC/MAC-CE/DCI). For example, the UE may be configured with an enable parameter by RRC, which is used to enable the AI/ML function, otherwise the AI/ML function is not allowed in the UE side. In this case, if the AI/ML function is disable, the UE may need to stop the current AI/ML related behavior. Therefore, the enabling of the AI/ML function should be a precondition for all UE behaviors mentioned above.

In some embodiments, the UE may receive a control command indicating that the AI/ML function is enabled.

The solution of the present disclosure described with reference to FIGS. 2-8 proposes a mechanism of AI-based beam/CSI prediction in time domain. With the solution, the signaling overhead and the latency due to the RRC/MAC-CE/DCI signaling for configuring or activating periodic or a semi-persistent report CSI report/resource may be reduced significantly.

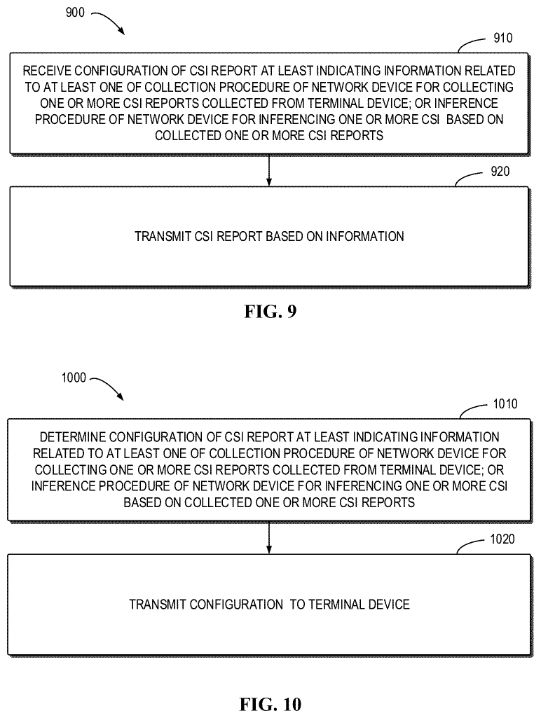

Now the reference is made to FIG. 9, which illustrates a flowchart of an example method 900 in accordance with some embodiments of the present disclosure. The method 900 can be implemented at a terminal device 110 as shown in FIG. 1. It is to be understood that the method 900 may include additional blocks not shown and/or may omit some blocks as shown, and the scope of the present disclosure is not limited in this regard.

At 910, the terminal device receives, from a network device, a configuration of Channel State Information, CSI, report at least indicating information related to at least one of: a collection procedure of the network device for collecting one or more CSI reports collected from the terminal device; or an inference procedure of the network device for inferencing one or more CSI based on the collected one or more CSI reports.

At 920, the terminal device transmits the CSI report based on the information, wherein the CSI report comprises at least one of a periodic CSI report, a semi-persistent CSI report and a first type of CSI report.

In some embodiments, the information indicates at least one of a first time duration including a second time duration within which the collection procedure is performed by the network device and a third time duration within which the inference procedure is performed by the network device, the second time duration, or the third time duration.

In some embodiments, the second time duration and the third time duration are non-overlapped or at least partially overlapped with each other.

In some embodiments, the configuration is received via at least one of: a radio resource control signaling, a medium access control-control element, or downlink control information.

In some embodiments, the method further comprises receiving, from the network device, an indication of an offset of the first time duration and a period of the first time duration.

In some embodiments, the indication is received via at least one of: a radio resource control signaling, a medium access control-control element, or downlink control information.

In some embodiments, the method further comprises determining an offset of the first time duration and a period of the first time duration based on a starting point and a period associated with the CSI report.

In some embodiments, the method further comprises causing the terminal device to not report the CSI report within the third time duration.

In some embodiments, the information indicates a first number associated with the collection procedure and a second number associated with the inference procedure, wherein the first number is the number of continuously CSI reports to be used as input data for the inference procedure and the second number is the number of prediction results to be output in the inference procedure.

In some embodiments, the method further comprises determining, based on the first and the second numbers, the CSI report to be dropped.

In some embodiments, the method further comprises determining a target frame number and a target slot number in the target frame based on the first and the second numbers; and determining, based on the target frame number and the target slot number, the CSI report to be dropped.

In some embodiments, the method further comprises receiving, from the network device and via a radio resource control signaling, an indication that: the CSI report is to be configured as the first type of CSI report, wherein the first type of CSI report is a discontinuous periodic type CSI report; or the CSI report is to be released from the first type of CSI report.

In some embodiments, the method further comprises receiving, from the network device, an indication that the CSI report is to be activated as the first type of CSI report or to be deactivated from the first type of CSI report via at least one of: a medium access control-control element, or downlink control information, wherein the first type of CSI report is a discontinuous periodic type CSI report.

In some embodiments, the downlink control information is scrambled with a discontinuous periodic CSI radio network temporary identity.

In some embodiments, the method further comprises occupying a central processing unit of the terminal device during the second time duration, or releasing the central processing unit of the terminal device within the third time duration.

In some embodiments, the method further comprises releasing a central processing unit of the terminal device for the CSI report determined based on the first and the second numbers.

In some embodiments, the method further comprises releasing a central processing unit of the terminal device for the CSI report determined based on the target frame number and the target slot number.

In some embodiments, the method further comprises omitting one or more CSI reference signal resources for a channel measurement in a latest CSI reference signal occasion no later than a CSI reference resource corresponding to the CSI report within the third time duration; or causing the terminal device to not receive a CSI reference signal for a channel measurement from the first symbol after an uplink channel carrying a latest CSI report to the last symbol before a CSI reference resource corresponding to the CSI report within the third time duration.

In some embodiments, the method further comprises omitting one or more CSI reference signal resources for a channel measurement in a latest CSI reference signal occasion no later than a CSI reference resource corresponding to the CSI report determined based on the first and the second numbers; or causing the terminal device to not receive a CSI reference signal for a channel measurement from the first symbol after an uplink channel carrying a latest CSI report to the last symbol before a CSI reference resource corresponding to the CSI report determined based on the first and the second numbers.

In some embodiments, the method further comprises omitting one or more CSI reference signal resources for a channel measurement in a latest CSI reference signal occasion no later than a CSI reference resource corresponding to the CSI report determined based on the target frame number and the target slot number; or causing the terminal device to not receive a CSI reference signal for a channel measurement from the first symbol after an uplink channel carrying a latest CSI report to the last symbol before a CSI reference resource corresponding to the CSI report determined based on the target frame number and the target slot number.

In some embodiments, the third time duration is less than a threshold duration which is less than 1280 ms.

In some embodiments, a time interval between the CSI report and the latest CSI-RS is less than 1280 ms.

In some embodiments, the method further comprises determining that a CSI reference signal is inactive in a duration of time starting from the first symbol after an uplink channel carrying a latest CSI report to the last symbol before a CSI reference resource corresponding to the CSI report associated with the CSI reference signal.

In some embodiments, the method further comprises in accordance with a determination that the CSI report associated with the information is collided with a further CSI report that is not associated with the information, performing a reporting of the CSI report associated with the information.

In some embodiments, the method further comprises in accordance with a determination that the CSI report is configured as the first type of CSI report and the CSI report is collided with a further CSI report that is configured as a periodic or semi-persistent type CSI report, performing a reporting of the CSI report, wherein the first type of CSI report is a discontinuous periodic type CSI report.

In some embodiments, the method further comprises receiving, from the network device, a control command indicating that the artificial intelligence or machine learning function is enabled, the collection procedure and the inference procedure being performed by the artificial intelligence or machine learning function.

In some embodiments, the method further comprises reporting, to the network device, one or more capabilities of the terminal device comprising: a maximum time duration for the collection procedure and the inference procedure allowed to be supported by the terminal device, a maximum time duration for the collection procedure allowed to be supported by the terminal device, a maximum time duration for the inference procedure allowed to be supported by the terminal device, a maximum value for a first number associated with the collection procedure allowed to be supported by the terminal device, or a maximum value for a second number associated with the inference procedure allowed to be supported by the terminal device.

In some embodiments, the terminal device comprises a terminal device and the network device comprises a network device.

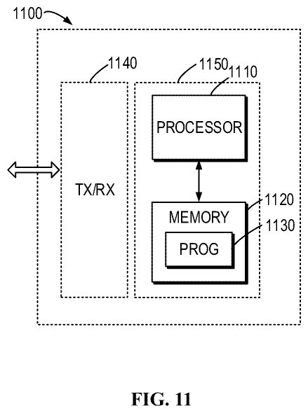

Now the reference is made to FIG. 10, which illustrates a flowchart of an example method 1000 in accordance with some embodiments of the present disclosure. The method 1000 can be implemented at a network device 120 as shown in FIG. 1. It is to be understood that the method 1000 may include additional blocks not shown and/or may omit some blocks as shown, and the scope of the present disclosure is not limited in this regard.

At 1010, the network device determines a configuration of Channel State Information, CSI, report at least indicating information related to at least one of: a collection procedure of the network device for collecting one or more CSI reports collected from the terminal device; or an inference procedure of the network device for inferencing one or more CSI based on the collected one or more CSI reports.

At 1020, the network device transmits the configuration to the terminal device.

In some embodiments, the information indicates at least one of a first time duration including a second time duration within which the collection procedure is performed by the network device and a third time duration within which the inference procedure is performed by the network device, the second time duration, or the third time duration.

In some embodiments, the second time duration and the third time duration are non-overlapped or at least partially overlapped with each other.

In some embodiments, the information indicates a first number associated with the collection procedure and a second number associated with the inference procedure, wherein the first number is the number of continuously CSI reports to be used as input data for the inference procedure and the second number is the number of prediction results to be output in the inference procedure.

In some embodiments, the method further comprises determining the configuration based on one or more capabilities of the terminal device comprising: a maximum time duration for the collection procedure and the inference procedure allowed to be supported by the terminal device, a maximum time duration for the collection procedure allowed to be supported by the terminal device, a maximum time duration for the inference procedure allowed to be supported by the terminal device, a maximum value for a first number associated with the collection procedure allowed to be supported by the terminal device, or a maximum value for a second number associated with the inference procedure allowed to be supported by the terminal device.

In some embodiments, the configuration is transmitted via at least one of: a radio resource control signaling, a medium access control-control element, or downlink control information.

In some embodiments, the method further comprises transmitting, to the terminal device, an indication of an offset of the first time duration and a period of the first time duration.

In some embodiments, the indication is transmitted via at least one of: a radio resource control signaling, a medium access control-control element, or downlink control information.

In some embodiments, the method further comprises transmitting, to the terminal device and via a radio resource control signaling, an indication that the CSI report is to be configured as the first type of CSI report, wherein the first type of CSI report is a discontinuous periodic type CSI report; or the CSI report is to be released from the first type of CSI report.

In some embodiments, the method further comprises transmitting, to the terminal device, an indication that the CSI report is to be activated as the first type of CSI report or to be deactivated from the first type of CSI report via at least one of: a medium access control-control element, or downlink control information, wherein the first type of CSI report is a discontinuous periodic type CSI report.

In some embodiments, the downlink control information is scrambled with a discontinuous periodic CSI radio network temporary identity.

In some embodiments, the method further comprises transmitting, to the terminal device, a control command indicating that the artificial intelligence or machine learning function is enabled, the collection procedure and the inference procedure being performed by the artificial intelligence or machine learning function.

Details for CSI prediction in time domain according to the present disclosure have been described with reference to FIGS. 2-10. Now an example implementation of the terminal device 110 will be discussed below. In some embodiments, the terminal device 110 comprises circuitry configured to:

In some embodiments, the terminal device 110 comprises circuitry configured to receive, from a network device, a configuration of Channel State Information, CSI, report at least indicating information related to at least one of: a collection procedure of the network device for collecting one or more CSI reports collected from the terminal device; or an inference procedure of the network device for inferencing one or more CSI based on the collected one or more CSI reports and transmit the CSI report based on the information, wherein the CSI report comprises at least one of a periodic CSI report, a semi-persistent CSI report and a first type of CSI report.

In some embodiments, the information indicates at least one of a first time duration including a second time duration within which the collection procedure is performed by the network device and a third time duration within which the inference procedure is performed by the network device, the second time duration, or the third time duration.

In some embodiments, the second time duration and the third time duration are non-overlapped or at least partially overlapped with each other.

In some embodiments, the configuration is received via at least one of: a radio resource control signaling, a medium access control-control element, or downlink control information.

In some embodiments, the terminal device 110 comprises circuitry configured to receive, from the network device, an indication of an offset of the first time duration and a period of the first time duration.

In some embodiments, the indication is received via at least one of: a radio resource control signaling, a medium access control-control element, or downlink control information.

In some embodiments, the terminal device 110 comprises circuitry configured to determine an offset of the first time duration and a period of the first time duration based on a starting point and a period associated with the CSI report.

In some embodiments, the terminal device 110 comprises circuitry configured to cause the terminal device to not report the CSI report within the third time duration.

In some embodiments, the information indicates a first number associated with the collection procedure and a second number associated with the inference procedure, wherein the first number is the number of continuously CSI reports to be used as input data for the inference procedure and the second number is the number of prediction results to be output in the inference procedure.

In some embodiments, the terminal device 110 comprises circuitry configured to determine, based on the first and the second numbers, the CSI report to be dropped.

In some embodiments, the terminal device 110 comprises circuitry configured to determine a target frame number and a target slot number in the target frame based on the first and the second numbers; and determine, based on the target frame number and the target slot number, the CSI report to be dropped.

In some embodiments, the terminal device 110 comprises circuitry configured to receive, from the network device and via a radio resource control signaling, an indication that: the CSI report is to be configured as the first type of CSI report, wherein the first type of CSI report is a discontinuous periodic type CSI report; or the CSI report is to be released from the first type of CSI report.

In some embodiments, the terminal device 110 comprises circuitry configured to receive, from the network device, an indication that the CSI report is to be activated as the first type of CSI report or to be deactivated from the first type of CSI report via at least one of: a medium access control-control element, or downlink control information, wherein the first type of CSI report is a discontinuous periodic type CSI report.

In some embodiments, the downlink control information is scrambled with a discontinuous periodic CSI radio network temporary identity.

In some embodiments, the terminal device 110 comprises circuitry configured to occupy a central processing unit of the terminal device during the second time duration, or release the central processing unit of the terminal device within the third time duration.

In some embodiments, the terminal device 110 comprises circuitry configured to releasing a central processing unit of the terminal device for the CSI report determined based on the first and the second numbers.

In some embodiments, the terminal device 110 comprises circuitry configured to release a central processing unit of the terminal device for the CSI report determined based on the target frame number and the target slot number.

In some embodiments, the terminal device 110 comprises circuitry configured to omit one or more CSI reference signal resources for a channel measurement in a latest CSI reference signal occasion no later than a CSI reference resource corresponding to the CSI report within the third time duration; or cause the terminal device to not receive a CSI reference signal for a channel measurement from the first symbol after an uplink channel carrying a latest CSI report to the last symbol before a CSI reference resource corresponding to the CSI report within the third time duration.

In some embodiments, the terminal device 110 comprises circuitry configured to omit one or more CSI reference signal resources for a channel measurement in a latest CSI reference signal occasion no later than a CSI reference resource corresponding to the CSI report determined based on the first and the second numbers; or cause the terminal device to not receive a CSI reference signal for a channel measurement from the first symbol after an uplink channel carrying a latest CSI report to the last symbol before a CSI reference resource corresponding to the CSI report determined based on the first and the second numbers.

In some embodiments, the terminal device 110 comprises circuitry configured to omit one or more CSI reference signal resources for a channel measurement in a latest CSI reference signal occasion no later than a CSI reference resource corresponding to the CSI report determined based on the target frame number and the target slot number; or cause the terminal device to not receive a CSI reference signal for a channel measurement from the first symbol after an uplink channel carrying a latest CSI report to the last symbol before a CSI reference resource corresponding to the CSI report determined based on the target frame number and the target slot number.

In some embodiments, the third time duration is less than a threshold duration which is less than 1280 ms.

In some embodiments, a time interval between the CSI report and the latest CSI-RS is less than 1280 ms.

In some embodiments, the terminal device 110 comprises circuitry configured to determine that a CSI reference signal is inactive in a duration of time starting from the first symbol after an uplink channel carrying a latest CSI report to the last symbol before a CSI reference resource corresponding to the CSI report associated with the CSI reference signal.

In some embodiments, the terminal device 110 comprises circuitry configured to in accordance with a determination that the CSI report configured with the information is collided with a further CSI report that is configured with the information, perform a reporting of the CSI report based on the information.

In some embodiments, the terminal device 110 comprises circuitry configured to in accordance with a determination that the CSI report is configured as the first type of CSI report and the CSI report is collided with a further CSI report that is configured as the first type of CSI report, perform a reporting of the CSI report, wherein the first type of CSI report is a discontinuous periodic type CSI report.

In some embodiments, the terminal device 110 comprises circuitry configured to receive, from the network device, a control command indicating that the artificial intelligence or machine learning function is enabled, the collection procedure and the inference procedure being performed by the artificial intelligence or machine learning function.

In some embodiments, the terminal device 110 comprises circuitry configured to report, to the network device, one or more capabilities of the terminal device comprising: a maximum time duration for the collection procedure and the inference procedure allowed to be supported by the terminal device, a maximum time duration for the collection procedure allowed to be supported by the terminal device, a maximum time duration for the inference procedure allowed to be supported by the terminal device, a maximum value for a first number associated with the collection procedure allowed to be supported by the terminal device, or a maximum value for a second number associated with the inference procedure allowed to be supported by the terminal device.

Now an example implementation of the network device 120 will be discussed below. In some embodiments, the network device 120 comprises circuitry configured to: determine a configuration of Channel State Information, CSI, report at least indicating information related to at least one of: a collection procedure of the network device for collecting one or more CSI reports collected from the terminal device; or an inference procedure of the network device for inferencing one or more CSI based on the collected one or more CSI reports and transmit the configuration to the terminal device.

In some embodiments, the information indicates at least one of a first time duration including a second time duration within which the collection procedure is performed by the network device and a third time duration within which the inference procedure is performed by the network device, the second time duration, or the third time duration.

In some embodiments, the second time duration and the third time duration are non-overlapped or at least partially overlapped with each other.

In some embodiments, the information indicates a first number associated with the collection procedure and a second number associated with the inference procedure, wherein the first number is the number of continuously CSI reports to be used as input data for the inference procedure and the second number is the number of prediction results to be output in the inference procedure.

In some embodiments, the network device 120 comprises circuitry configured to determine the configuration based on one or more capabilities of the terminal device comprising: a maximum time duration for the collection procedure and the inference procedure allowed to be supported by the terminal device, a maximum time duration for the collection procedure allowed to be supported by the terminal device, a maximum time duration for the inference procedure allowed to be supported by the terminal device, a maximum value for a first number associated with the collection procedure allowed to be supported by the terminal device, or a maximum value for a second number associated with the inference procedure allowed to be supported by the terminal device.

In some embodiments, the configuration is transmitted via at least one of: a radio resource control signaling, a medium access control-control element, or downlink control information.

In some embodiments, the network device 120 comprises circuitry configured to transmit, to the terminal device, an indication of an offset of the first time duration and a period of the first time duration.

In some embodiments, the indication is transmitted via at least one of: a radio resource control signaling, a medium access control-control element, or downlink control information.

In some embodiments, the network device 120 comprises circuitry configured to transmit, to the terminal device and via a radio resource control signaling, an indication that the CSI report is to be configured as the first type of CSI report, wherein the first type of CSI report is a discontinuous periodic type CSI report; or the CSI report is to be released from the first type of CSI report.

In some embodiments, the network device 120 comprises circuitry configured to transmit, to the terminal device, an indication that the CSI report is to be activated as the first type of CSI report or to be deactivated from the first type of CSI report via at least one of: a medium access control-control element, or downlink control information, wherein the first type of CSI report is a discontinuous periodic type CSI report.

In some embodiments, the downlink control information is scrambled with a discontinuous periodic CSI radio network temporary identity.

In some embodiments, the network device 120 comprises circuitry configured to transmit, to the terminal device, a control command indicating that the artificial intelligence or machine learning function is enabled, the collection procedure and the inference procedure being performed by the artificial intelligence or machine learning function.

FIG. 11 is a simplified block diagram of a device 1100 that is suitable for implementing embodiments of the present disclosure. The device 1100 can be considered as a further example implementation of the terminal device 110 or the network device 120 as shown in FIG. 1. Accordingly, the device 1100 can be implemented at or as at least a part of the terminal device 110 or the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2A to 6. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrations operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separation embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method comprising:
receiving, at a terminal device and from a network device, a configuration of Channel State Information, CSI, report at least indicating information related to at least one of:
a collection procedure of the network device for collecting one or more CSI reports collected from the terminal device; or
an inference procedure of the network device for inferencing one or more CSI based on the collected one or more CSI reports;
transmitting the CSI report based on the information, wherein the CSI report comprises at least one of a periodic CSI report, a semi-persistent CSI report and a first type of CSI report.

2. The method of claim 1, wherein the information indicates at least one of:
a first time duration including a second time duration within which the collection procedure is performed by the network device and a third time duration within which the inference procedure is performed by the network device,
the second time duration, or
the third time duration.

3. The method of claim 2, wherein the second time duration and the third time duration are non-overlapped or at least partially overlapped with each other.

4. The method of claim 1, wherein the configuration is received via at least one of:
a radio resource control signaling,
a medium access control-control element, or
downlink control information.

5-7. (canceled)

8. The terminal device of claim 2, wherein transmitting the CSI report based on the information comprises:
causing the terminal device to not report the CSI report within the third time duration.

9. The method of claim 1, wherein the information indicates a first number associated with the collection procedure and a second number associated with the inference procedure, wherein the first number is the number of continuously CSI reports to be used as input data for the inference procedure and the second number is the number of prediction results to be output in the inference procedure.

10. The method of claim 9, further comprising:
determining, based on the first and the second numbers, the CSI report to be dropped.

11. The method of claim 9, further comprising:
determining a target frame number and a target slot number in the target frame based on the first and the second numbers; and
determining, based on the target frame number and the target slot number, the CSI report to be dropped.

12-14. (canceled)

15. The method of claim 2, further comprising:
occupying a central processing unit of the terminal device during the second time duration, or
releasing the central processing unit of the terminal device within the third time duration.

16. The method of claim 10, further comprising:
releasing a central processing unit of the terminal device for the CSI report determined based on the first and the second numbers.

17. The method of claim 11, further comprising:
releasing a central processing unit of the terminal device for the CSI report determined based on the target frame number and the target slot number.

18. The method of claim 2, further comprising:
omitting one or more CSI reference signal resources for a channel measurement in a latest CSI reference signal occasion no later than a CSI reference resource corresponding to the CSI report within the third time duration; or
causing the terminal device to not receive a CSI reference signal for a channel measurement from the first symbol after an uplink channel carrying a latest CSI report to the last symbol before a CSI reference resource corresponding to the CSI report within the third time duration.

19. The method of claim 10, further comprising:
omitting one or more CSI reference signal resources for a channel measurement in a latest CSI reference signal occasion no later than a CSI reference resource corresponding to the CSI report determined based on the first and the second numbers; or
causing the terminal device to not receive a CSI reference signal for a channel measurement from the first symbol after an uplink channel carrying a latest CSI report to the last symbol before a CSI reference resource corresponding to the CSI report determined based on the first and the second numbers.

20. The method of claim 11, further comprising:
omitting one or more CSI reference signal resources for a channel measurement in a latest CSI reference signal occasion no later than a CSI reference resource corresponding to the CSI report determined based on the target frame number and the target slot number; or
causing the terminal device to not receive a CSI reference signal for a channel measurement from the first symbol after an uplink channel carrying a latest CSI report to the last symbol before a CSI reference resource corresponding to the CSI report determined based on the target frame number and the target slot number.

21. The method of claim 2, wherein the third time duration is less than a threshold duration which is less than 1280 ms.

22. The method of claim 18, wherein a time interval between the CSI report and the latest CSI reference signal is less than 1280 ms, wherein the latest CSI reference signal is a latest CSI reference signal associated with the CSI report.

23. (canceled)

24. The method of claim 1, further comprising:
in accordance with a determination that the CSI report associated with the information is collided with a further CSI report that is not associated with the information, performing a reporting of the CSI report associated with the information.

25-26. (canceled)

27. The method of claim 1, further comprising:
reporting, to the network device, one or more capabilities of the terminal device comprising:
a maximum time duration for the collection procedure and the inference procedure allowed to be supported by the terminal device,
a maximum time duration for the collection procedure allowed to be supported by the terminal device,
a maximum time duration for the inference procedure allowed to be supported by the terminal device,
a maximum value for a first number associated with the collection procedure allowed to be supported by the terminal device, or
a maximum value for a second number associated with the inference procedure allowed to be supported by the terminal device.

28. A method comprising:
determining, at a network device, a configuration of Channel State Information, CSI, report at least indicating information related to at least one of:
a collection procedure of the network device for collecting one or more CSI reports collected from a terminal device based on the collected one or more CSI reports; or
an inference procedure of the network device for inferencing one or more CSI based on the collected one or more CSI reports; and
transmitting the configuration to the terminal device.

29-39. (canceled)

40. A terminal device, comprising:
a processor configured to:
receive, from a network device, a configuration of Channel State Information, CSI, report at least indicating information related to at least one of:
a collection procedure of the network device for collecting one or more CSI reports collected from the terminal device; or
an inference procedure of the network device for inferencing one or more CSI based on the collected one or more CSI reports;
transmit the CSI report based on the information, wherein the CSI report comprises at least one of a periodic CSI report, a semi-persistent CSI report and a first type of CSI report.

41-42. (canceled)
